(19) United States
(12) Patent Application Publication
(10) Pub. No.: US 2026/0206105 A1
(43) Pub. Date: Jul. 16, 2026

(54) DEVICE AND METHOD FOR GENERATING ELECTROPLASMIC HEAT

(71) Applicants: COMMISSARIAT A L'ENERGIE ATOMIQUE ET AUX ENERGIES ALTERNATIVES, Paris (FR); INSTITUT LOUIS DE BROGLIE, Paris (FR)

(72) Inventors: Gaëtan DE LACHEZE-MUREL, Soisy sur Seine (FR); Michel KARATCHENTZEFF, Croissy-Beaubourg (FR); Pierre CLAUZON, Paris (FR); Daniel FARGUE, Paris (FR)

(73) Assignees: COMMISSARIAT A L'ENERGIE ATOMIQUE ET AUX ENERGIES ALTERNATIVES, Paris (FR); INSTITUT LOUIS DE BROGLIE, Paris (FR)

(21) Appl. No.: 19/134,575

(22) PCT Filed: Nov. 30, 2023
(86) PCT No.: PCT/EP2023/083681

§ 371 Date: May 30, 2025

(30) Foreign Application Priority Data
Dec. 2, 2022 (FR) FR2212722

(51) Int. Cl. H05B 7/06; H05B 7/00; H05B 7/11; H05B 7/144; H05H 1/24

(52) U.S. Cl. CPC H05B 7/06; H05B 7/005; H05B 7/11; H05B 7/144; H05H 1/247

(57) ABSTRACT

Device and method for generating electro-plasma heat The invention relates to a heat generation device (100) comprising: —a chamber (11) containing a liquid electrolyte (14), —a first electrode (12) in the form of a wire and a second electrode (13) extending over a surface, preferably flat, arranged in a so-called wire-surface configuration with the first electrode, the first and second electrodes being at least partially immersed in the liquid electrolyte, —a power supply (16) configured to generate an electric voltage, preferably in the form of pulses, between the first and second electrodes in order to generate a plasma around the first electrode.

### TECHNICAL FIELD

The present invention relates to the fields of thermics, calorimetry and medium- and high-voltage electrical circuits. It relates more particularly to a device and an associated method for generating heat.

The invention also relates to an apparatus for heating a fluid implementing the device for generating heat.

### PRIOR ART

Heating a liquid, such as water, is commonly performed by ohmic heating. For this purpose, an electrical resistor is subjected to a DC or AC voltage U in an electrical circuit through which a current I flows. The resistor then emits a power P=UI=RI² which can be used to heat the liquid.

The inventors have, however, demonstrated that it is possible to generate thermal energy which is greater than the electrical energy supplied, as described in the article [1].

As depicted in FIGS. 1 to 3, the device 1 described in this article [1] comprises two electrodes 2, 3 immersed in pure water, the water having an electrical conductivity of less than a few microsiemens per centimeter. One of the electrodes 2 is in the form of a point and arranged in a configuration referred to as a point-plane configuration with the other of the two electrodes 3, which is flat. The two electrodes 2, 3 are arranged at a distance of the order of 0.1 mm from one another. The pure water between the two electrodes constitutes an electrical resistor 4 between them.

The application of a voltage between the electrodes generates discharges in the following manner. In a first stage, and as depicted in FIGS. 1 and 2, a water vapor channel 5 (streamer) is formed and progresses from a first electrode to the second electrode. This channel is created by the strong electric field between the two electrodes which makes it possible to ionize the generated water vapor. During this phase, which may last several tens of microseconds, the voltage between the electrodes remains high and the current low. Ohmic heating of liquid water takes place between the end of the vapor channel and the second electrode.

In a second stage and as depicted in FIG. 3, the water vapor channel 5 reaches the second electrode. Because of its ionization, the vapor channel has a very low electrical resistance, which causes the resistance between the electrodes 2, 3 to drop. The voltage across the terminals of the electrodes drops and the strength of the current increases, causing an electric discharge. The measured generated energy is greater than the delivered energy, at least under certain conditions.

FIG. 4 depicts the typical temporal evolution of the current I and the voltage U across the terminals of the electrodes 2, 3 as a function of time t. In the example of FIG. 4, a voltage of about 900 V is applied at t=0 s. The voltage remains substantially constant during the first phase of creating a vapor channel by ohmic heating and the current remains low at about 10 A, corresponding to a resistance R=U/I=110 ohms. When the electric discharge between the electrodes occurs, the voltage drops and the strength of the current increases due to the passage of the current through the vapor channel. During this phase, the voltage falls to about 80 V and the current reaches 200 A, corresponding to a resistance R=U/I=0.4 ohms.

The device 1 described in the article [1], as illustrated in FIGS. 1 to 3, is, however, difficult to implement in the context of an industrial use of the heating of liquid or the generation of vapor.

In the first place, obtaining discharges in pure water requires a very precise geometry of the electrodes. At least one of the electrodes must have a very small radius of curvature, of the order of 0.1 mm, in order to benefit from the point effect. In addition, the distance between the electrodes must be small, of the order of 0.1 mm, and maintained very precisely.

However, the electric discharges generate a pressure which is capable of moving the electrodes. In order to avoid this, sufficiently massive electrodes having a diameter of the order of several millimeters must be used: this therefore prevents the use of wire electrodes, that is to say electrodes of small diameter, for example less than or equal to 2 mm. The end of the point electrode must then be precisely sharpened in order to obtain a sufficiently small radius of curvature.

Moreover, the passage of the electric current during a discharge wears the electrodes, notably by ablation and by hollowing. This limits the number of discharges to a few thousand and would therefore require an electrode changing frequency which is prohibitive for industrial use.

In addition, the wear of the electrodes pollutes the water in which discharges are performed due to particle ablation. This pollution may make the water sufficiently conductive to prevent the formation of a plasma which is necessary for obtaining energy gains. When the conductivity of the water becomes too high, the passage of the current between the electrodes produces only ohmic heating.

FIG. 5 illustrates the evolution of the current I and the voltage U as a function of time t for the same device as a function of a number of discharges N. More precisely, a number of 1352 discharges were performed at a frequency of 2.7 discharges per second. It is apparent from FIG. 5 that the average time for creating the vapor channel increases with repeated discharges, which reflects the wear of the electrodes.

The unstable nature of the discharges is also apparent from this FIG. 5: indeed, in parallel with the average increase in time to create the vapor channel, significant and random variation of this time is observed, highlighting the instability of the phenomenon.

There is therefore a need to improve existing heating devices which are capable of generating thermal energy which is greater than the electrical energy which powers them, notably to improve their predictability and their lifetime.

The aim of the invention is to at least partially meet this need.

### SUMMARY OF THE INVENTION

For this purpose, the invention relates, according to one of its aspects, to a device for generating heat, comprising:
a chamber containing a liquid electrolyte,
a first electrode in the form of a wire and a second electrode which extends along a, preferably flat, surface and is arranged in a configuration referred to as a wire-surface configuration with the first electrode, the first and second electrodes being immersed at least partially in the liquid electrolyte,
an electrical power supply configured to generate a voltage, preferably in the form of pulses, between the first and second electrodes so as to generate a plasma around the first electrode.

“Liquid electrolyte” is understood here and in the context of the invention to have the usual meaning, namely a liquid which makes the passage of the electric current possible, because of the presence of mobile ions within it.

Advantageously, the invention makes it possible to obtain high-efficiency heating. Indeed, the inventors have found, following several hundred experiments, that the thermal energy generated by the device according to the invention may be greater than 1.5 times the electrical energy delivered to the device, reaching up to 4 to 8 times this value. The invention therefore makes possible significant energy savings.

Without being bound by a theory, the inventors observe that this energy gain is linked to the formation of a plasma around the first electrode in the form of a wire. This hot and dense plasma is confined by the liquid electrolyte and seems to be the site of the observed amplification phenomenon.

In order to create a plasma around the first electrode, the density of the electrical energy deposit in the liquid electrolyte must be sufficient to create a volume of water vapor. The electric field must also be sufficiently strong to ionize the water vapor.

Without being bound by this theory, the inventors think that the plasma is formed by a corona effect.

As will be seen in more detail below, the device according to the invention makes it possible to form a plasma in a stable manner and without notable wear of the electrodes, unlike the device according to the prior art, described in relation to FIGS. 1 to 5.

According to an advantageous embodiment, the first electrode has a diameter of between 0.1 mm and 2 mm.

Preferably, the distance between the first and second electrodes is greater than 1 mm, preferably 2 mm, 5 mm or 10 mm. It may be less than 50 cm, 10 cm or 5 cm.

According to a preferred embodiment, the conductivity of the liquid electrolyte and the distance between the first and second electrodes are chosen so that the resistance of the liquid electrolyte between them is less than or equal to 20 ohms, preferably 10 ohms or 5 ohms.

Advantageously, the liquid electrolyte is a mixture of water and a base or an acid, in particular a mixture of water and sodium hydroxide.

Preferably, the chamber comprises a system for draining the liquid electrolyte in order to make it possible to replace it. The draining system may be configured to make it possible to continuously replace the liquid electrolyte and/or to make it possible to completely drain and replace the volume of liquid electrolyte in the chamber.

According to an advantageous feature, one wall of the chamber forms the second electrode.

The chamber preferably has a volume of between 0.1 liters and 10 liters. Also preferably, the chamber is hermetically closed.

The invention also relates to an apparatus for heating a fluid, comprising:
a container containing the fluid, and
a device for generating heat according to the invention, wherein the chamber of the device is hermetically closed and arranged in the container and in contact with the fluid.

The invention finally relates to an operating method of the device for generating heat according to the invention, comprising a step consisting in applying, in pulses, a voltage, preferably between 100 V and 10 000 V, between the electrodes by means of the electrical power supply so as to generate a plasma around the first electrode.

According to an advantageous feature, the voltage is applied in pulses of a duration of between 1 μs and 10 ms.

Preferably, the sign of the applied voltage is alternated between positive and negative between two consecutive pulses.

Other advantages and features of the invention will become more clearly apparent upon reading the detailed description of exemplary implementations of the invention, given by way of non-limiting illustration with reference to the following figures.

### BRIEF DESCRIPTION OF THE DRAWINGS

FIGS. 1 to 3 depict the various operating steps of a heating device according to the prior art.

FIG. 4 is a graph depicting the typical temporal evolution of the voltage and of the current across the terminals of the electrodes of the device according to FIGS. 1 to 3.

FIG. 5 is a graph depicting the evolution of voltage and current as a function of the number of discharges which are performed on the same device according to the prior art.

FIG. 6 depicts a device for generating heat according to the invention.

FIG. 7 is a profile view of a subassembly of the device of FIG. 6.

FIG. 8 is a front view of the subassembly of FIG. 7.

FIG. 9 is a graph depicting the typical temporal evolution of the voltage and of the current across the terminals of the electrodes of the device of FIGS. 6 to 8.

FIG. 10 is a graph depicting the evolution of voltage and current as a function of the number of discharges which are performed on the same device according to the invention.

FIG. 11 depicts a device according to the invention in a configuration which makes it possible to measure the generated thermal energy.

FIG. 12 illustrates an apparatus for heating a fluid comprising a device for generating heat according to the invention.

### DETAILED DESCRIPTION

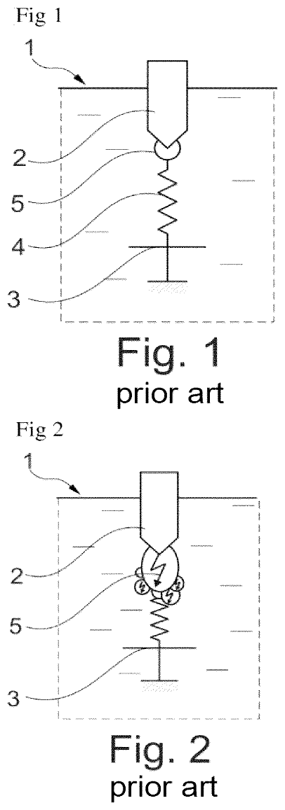

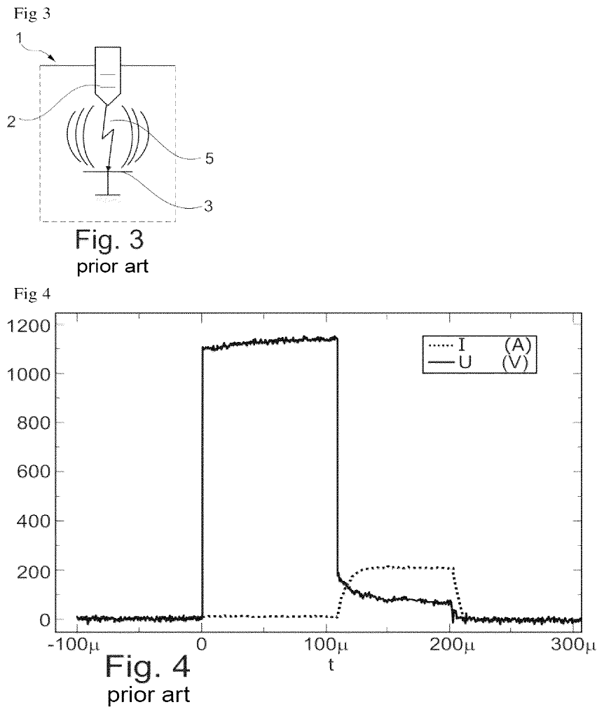

FIGS. 1 to 5 have already been described in detail in the preamble; they will therefore not be commented on below.

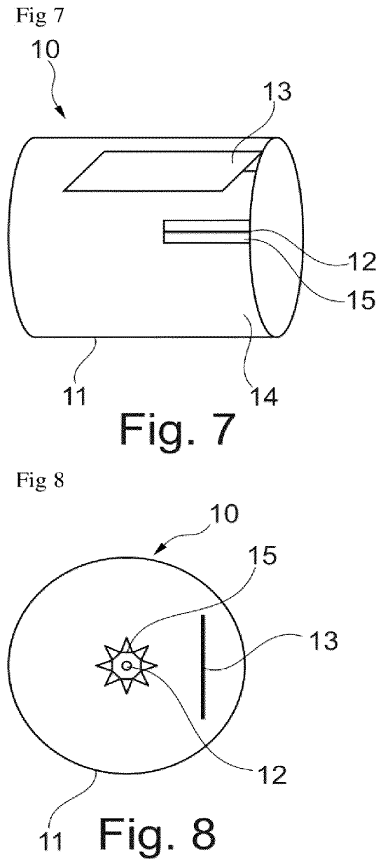

FIGS. 6 to 8 illustrate a device 100 for generating heat according to the invention.

In the illustrated example, the device 100 comprises a subassembly 10 which comprises a chamber 11 containing a liquid electrolyte 14.

A first electrode 12 and a second electrode 13 are immersed in the liquid electrolyte 14.

The first electrode 12 is in the form of a wire, that is to say a solid cylinder of small diameter.

The second electrode 13 extends along a surface and is arranged in a wire-surface configuration with the first electrode 12. The second electrode 13 is preferably a flat electrode. However, it may also be curved. Preferably, the surface area of the second electrode 13 is greater than 1 cm², 10 cm², 50 cm² or 100 cm² and/or less than 1000 cm².

The first electrode and the second electrode are connected to an electrical power supply 16 configured to generate a voltage across the terminals of the electrodes. The electrical power supply 16 may notably be a generator or may originate from an electrical grid.

In the illustrated embodiment, a switch 17 makes it possible to selectively connect the electrical power supply 16 to the second electrode 13 and a capacitor 18 is disposed between the terminals of the electrical power supply 16. The electrodes 12, 13 are also each connected to a terminal of the capacitor 18.

### Operation

In operation, the electrical power supply charges the capacitor 18 until a defined voltage is reached, the switch 17 remaining open. Once the capacitor has been charged, the switch 17 may be closed, which causes the capacitor 18 to partially discharge. A current which may reach several tens to several hundred amperes flows through the circuit for a short time, typically between a few microseconds and a few milliseconds.

This generates a plasma 15 around the first electrode 12 in the liquid electrolyte. The plasma 15 is obtained by ionization of the water vapor generated around the first electrode.

The switch 17 is then opened and the capacitor 18 is recharged. After recharging, a new discharge may take place in order to continue heating the electrolyte.

Advantageously, the capacitor may be chosen so that its capacitance is sufficient for, at each discharge, the electric charge which it releases into the circuit to be small with respect to its total charge. This makes it possible to maintain a quasi-constant voltage during the discharge of the capacitor.

The inventors have found that the generation of the plasma 15 leads to an excess of energy, the generated thermal energy being greater than the electrical energy delivered to the device.

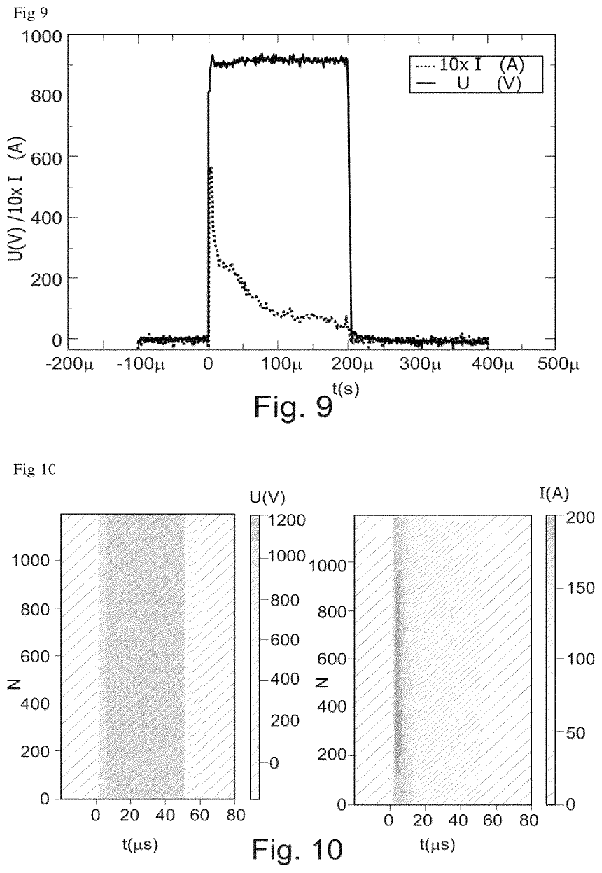

FIG. 9 shows the typical evolution of the voltage across the terminals of the electrodes and of the strength of the current running through the circuit during a discharge. It is observed that the voltage U is substantially constant at 900 V during its application duration of approximately 200 μs. The current is strong from the start of the discharge then decreases until it becomes substantially zero. The plasma is created from the start of the discharge.

In comparison with the typical evolution of the voltage and of the current which is depicted in FIG. 4, it is noted that the voltage and current profiles are very different in nature. There is, indeed, no creation of an ionized vapor channel followed by the creation of a plasma with a strong current passing under a low voltage. Because of the conductivity of the electrolyte 14, the strength of the current is high from the start of the discharge.

Advantageously, the electrodes of the device according to the invention are therefore not subjected to a violent shock corresponding to the dielectric breakdown when the ionized vapor channel connects the two electrodes in the device according to the prior art: the integrity of the electrodes is preserved and their wear is much less significant. This makes it possible notably to use an electrode 12 with a wire of small diameter and to improve the lifetime of the device.

### Sizing

The generation of the plasma around the first electrode 12 may be obtained with various configurations of the device. The conductivity of the liquid electrolyte, the diameter of the first electrode 12 and the voltage applied to the terminals of the electrodes 12, 13 are in particular chosen to perform the desired generation of the plasma.

In order to create a plasma around the first electrode, the density of the electrical energy deposit in the liquid electrolyte must be sufficient to create a volume of water vapor. The electric field must also be sufficiently strong to ionize the water vapor.

The distance between the electrodes is therefore not a major factor in obtaining a plasma. However, it is preferably ensured that the distance between the electrodes is greater than the spatial extension of the formed plasma, i.e. a distance which is typically greater than 1 mm, 2 mm, 5 mm or 10 millimeters. Also preferably, the distance between the electrodes is large enough to avoid forward breakdowns by creating a vapor channel between the electrodes. This distance depends on the voltage used and is typically of the order of 1 mm to 10 mm.

Preferably, the conductivity of the liquid electrolyte is chosen so that it has an electrical resistance between the first and second electrodes which is less than or equal to 20 ohms, preferably 10 ohms or 5 ohms. However, a lower conductivity is possible if the applied voltage is sufficiently high.

Alternatively or in combination, the conductivity of the liquid electrolyte is preferably greater than 1 S/m, 2 S/m, 4 S/m or 10 S/m.

The liquid electrolyte is preferably water mixed with a base or with an acid. In particular, the liquid electrolyte may be a mixture of water and sodium hydroxide at a concentration of between 0.05 mol/l and 1 mol/l.

The first electrode is an electrode in the form of a wire, that is to say a cylinder of circular cross section. Its diameter is chosen to make it possible to generate the plasma as a function of the applied voltage. The formation of the plasma is facilitated when the diameter of the first electrode is small. A cylinder the diameter of which is between 0.1 mm and 2 mm is preferably chosen. A larger diameter can be envisaged if it makes it possible to obtain a plasma.

The length of the first electrode is preferably greater than or equal to 1 cm and less than or equal to 10 m, 5 m or 10 cm. In particular, a length of the order of a meter is well suited in a heating apparatus such as a large hot water tank. In this case, a large current flows through the circuit and the capacitor and the electrical power supply may be sized accordingly.

Preferably, the first electrode is metallic, notably made of copper, iron, nickel, palladium, tantalum or tungsten.

The higher the voltage applied between the electrodes, the larger the electric field, promoting the ionization of the water vapor. However, the use of high voltages requires suitable electrical equipment and stricter safety conditions. The choice of the voltage used will therefore depend on the conditions of implementation of the invention. Voltages of between 100 V and 4000 V are preferably used.

Advantageously, the voltage applied between the electrodes is applied in pulses of short duration, preferably between 1 μs and 10 ms.

The applied voltage may be constant during a pulse. It may be identical for each of the pulses. Alternatively, the sign of the applied voltage may be changed after a certain number of pulses which are produced, in particular after each pulse. An alternation of positive and negative voltage pulses is obtained in this case.

Alternatively or in combination, the frequency of the pulses may be variable. In particular, a first series of pulses may be produced at a high frequency, followed by a pause of a duration preferably of between 1 s and 10 s, and then a new series of pulses may be produced at a high frequency, with a voltage of the same sign or opposite sign as that used during the first series of pulses.

Other voltage time profiles may also be used.

### Example

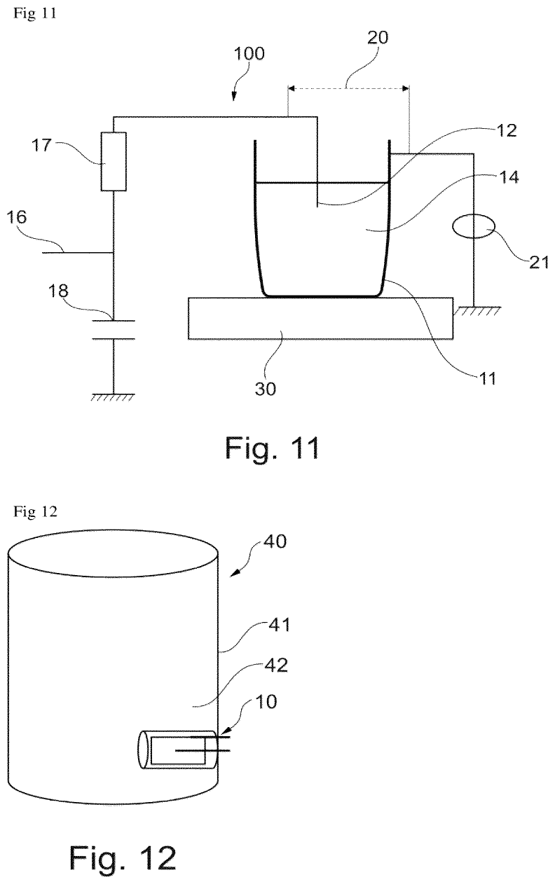

In an example of an implementation of the invention illustrated in FIG. 11, the chamber 11 is made of steel and has a cylindrical shape with a diameter of 13 cm and a length of 15 cm.

The chamber is open on an upper face and contains a mixture of water and sodium hydroxide forming a liquid electrolyte.

A first electrode 12 is immersed in the liquid electrolyte to a depth of between 0.5 cm and 3 cm. The first electrode extends along the central axis of the chamber, at a distance of 6.5 cm from its wall. The first electrode 12 is metallic, preferably made of copper, iron, nickel, palladium, tantalum or tungsten, and is a straight cylinder with a diameter of between 0.1 mm and 2 mm.

The cylindrical wall of the chamber 11, connected to the electrical ground, constitutes the second electrode 13.

Table 1 details the results of measurements obtained for a discharge with the device described as a function of the sodium hydroxide concentration of the conductive liquid and of the voltage imposed between the electrodes.

TABLE 1

| Sodium hydroxide | Imposed | Maximum | Maximum | Energy per |
|---|---|---|---|---|
| concentration | voltage | current | power | discharge |
| mol/l | V | A | kW | J |
| 0 | 1000 | 1.7 | 1.7 | 0.24 |
| 0.1 | 1000 | 85 | 83 | 4 |
| 0.2 | 1000 | 190 | 185 | 5.5 |
| 0.3 | 1000 | 270 | 250 | 9.2 |
| 0.8 | 600 | 580 | 365 | 8 |

For a zero concentration of sodium hydroxide, that is to say using pure water, it is found that the thermal energy generated is modest and less than the electrical energy delivered. The inventors have found that no plasma is formed in these experimental conditions with the configuration of the device used.

For sodium hydroxide concentrations which are greater than or equal to 0.1 mol/l, the inventors were able to obtain the formation of a plasma and found that the thermal energy generated is high, greater than the electrical energy delivered.

Moreover, table 1 shows that the current flowing through the circuit increases sharply with the sodium hydroxide concentration. In these conditions, it may be preferable to lower the imposed voltage in order to limit the strength of the current.

FIG. 10 depicts the evolution of the current I and of the voltage U as a function of time t for the same device as a function of the number of discharges N.

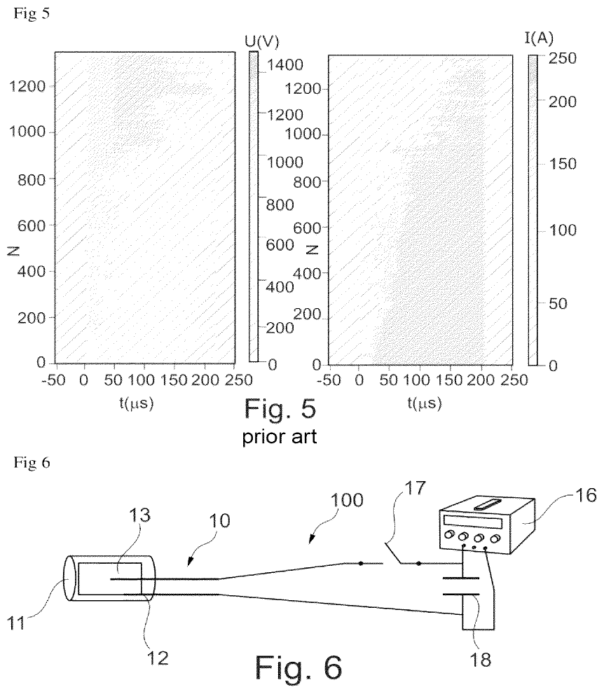

Contrary to what is observed in FIG. 5, the duration of the discharges which are obtained with the device according to the invention does not exhibit any significant variation from one discharge to another: the phenomenon is stable.

In addition, no wear of the electrodes is found: the performance of the device remains constant with the number of discharges. Visually, the inventors also found that no wear is apparent on the electrodes, even after several tens of thousands of discharges.

### Measurement of the Thermal Energy Obtained

In order to measure the thermal energy emitted by a discharge of the device according to the invention, the following measurement method may be used.

The principle of the measurement method consists in heating the conductive liquid to the boiling limit and in measuring the decrease in mass in the chamber during the discharges, which corresponds to the evaporation of some of the liquid contained in the chamber.

Thus, the measurement method makes it possible to obtain the evaporation rate with and without discharges of the device for generating heat according to the invention, which leads to the thermal energy generated by the discharges.

As illustrated in FIG. 11, the measurement method implements a balance 30 on which the chamber 11 of the device for generating heat is arranged. The balance makes it possible to measure the decrease in the mass of the liquid contained in the chamber.

The first electrode 12 is connected to the electrical power supply 16. An insulated-gate bipolar transistor acts as a switch 17 between the first electrode 12 and the electrical power supply 16. The device for generating heat also comprises a capacitor 18 arranged between the electrical power supply and the electrical ground.

The wall of the chamber 11 acts as a second electrode and is connected to ground.

The voltage between the first electrode 12 and the substantially cylindrical wall of the chamber 11 acting as the second electrode is measured by a voltage measurement device 20.

The current between the wall of the chamber and the electrical ground is measured by a current measurement device 21.

### Applications

The device for generating heat according to the invention makes it possible to heat the liquid electrolyte in which the electrodes are immersed. The heat generated may be transmitted by conduction to a medium which is external to the device.

The chamber 11 may thus replace the resistance of a hot water tank in order to heat water in a water heater. Similarly, the device for generating heat may be used to heat water for heating a building by replacing an electric or gas boiler.

FIG. 12 depicts an apparatus 40 for heating a fluid 42 comprising a container 41 containing the fluid 42. The chamber 11 of the device for generating heat is hermetically closed and is arranged in the container 41 in contact with the fluid, so that the heat generated in the chamber 11 is communicated to the fluid.

The heat generated by the device may also be used to produce water vapor, either by heating a separate water tank or by directly using the water vapor produced in the chamber 11.

Advantageously, the chamber 11 has a volume of between 0.1 and 10 liters.

Preferably, in the context of the use of an apparatus for heating a fluid, the device for generating heat generates discharges of a duration of between 1 μs and 10 ms at a frequency of 0.1 Hz to 100 kHz until the fluid reaches the desired temperature.

The water vapor generated may be used, in particular, to cook food, to perform vulcanization processes, to produce energy by making a turbine rotate, to perform steam cracking, to hydrate a medium such as paper in the process of being produced or indeed for methods for cleaning and/or sterilizing (floors, boilers, medical devices etc.).

The inventors have also found production of hydrogen in the hot plasma created during the discharge: the device according to the invention may therefore also make it possible to generate hydrogen.

Other variants and improvements may be provided without thereby departing from the scope of the invention.

### LIST OF CITED REFERENCES

[1]: “Décharges électriques dans l′eau: bilans d′énergie [Electric discharges in water: energy budgets]”, Clauzon et al., Annales de la Fondation Louis de Broglie [Annals of the Louis de Broglie Foundation], volume 43, number 1, pages 91-101, 2018.

1. A device for generating heat, comprising:
a chamber containing a liquid electrolyte,
a first electrode in the form of a wire and a second electrode which extends along a, preferably flat, surface and is arranged in a configuration referred to as a wire-surface configuration with the first electrode, the first and second electrodes being immersed at least partially in the liquid electrolyte,
an electrical power supply configured to generate a voltage, between the first and second electrodes so as to generate a plasma around the first electrode.

2. The device as claimed in claim 1, wherein the first electrode has a diameter of between 0.1 mm and 2 mm.

3. The device as claimed in claim 1, wherein the distance between the first and second electrodes is greater than 1 mm.

4. The device as claimed in claim 1, wherein the conductivity of the liquid electrolyte and the distance between the first and second electrodes are chosen so that the resistance of the liquid electrolyte between them is less than or equal to 20 ohms.

5. The device as claimed in claim 1, wherein the liquid electrolyte is a mixture of water and a base or an acid.

6. The device as claimed in claim 1, wherein the chamber comprises a system for draining the liquid electrolyte in order to make it possible to replace it.

7. The device as claimed in claim 1, wherein one wall of the chamber forms the second electrode.

8. The device as claimed in claim 1, wherein the chamber has a volume of between 0.1 liters and 10 liters.

9. An apparatus for heating a fluid, comprising:
a container containing the fluid and
a device as claimed in claim 1, wherein the chamber of the device is hermetically closed and arranged inside the container and in contact with the fluid.

10. An operating method of the device as claimed in claim 1, comprising applying, in pulses, a voltage, between 100 V and 10 000 V, between the first and second electrodes by the electrical power supply so as to generate a plasma around the first electrode.

11. The method as claimed in claim 10, wherein the voltage is applied in pulses of a duration of between 1 μs and 10 ms.

12. The method as claimed in claim 11, wherein the sign of the applied voltage is alternated between positive and negative between two consecutive pulses.
